(19) United States
(12) Patent Application Publication
(10) Pub. No.: US 2008/0089313 A1
(43) Pub. Date: Apr. 17, 2008

(54) TRACEABLE RECORD GENERATION SYSTEM AND METHOD USING WIRELESS NETWORKS

(76) Inventors: Jerald M. Cayo, Belvidere, IL (US); Derek J. Brykowski, Cary, IL (US); Terrence J. O'Neill, Lake Geneva, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 11/870,932

(22) Filed: Oct. 11, 2007

Related U.S. Application Data
(60) Provisional application No. 60/850,756, filed on Oct. 11, 2006.

(51) Int. Cl. H04J 3/00

(52) U.S. Cl. 370/345

(57) ABSTRACT

A data center in communication with a plurality of remote wireless clocks of a network comprises a server in communication with the network. The server is operable to send time information and non-time information through the network to a remote wireless clock among the remote wireless clocks. The server is also operable to receive status information through the network from the remote wireless clock, generate a traceable record based on the received status information, store the traceable record in a database, and host a software application for remote access by a user. The software application is operable to provide a plurality of functions associated with the remote wireless clock. The server is further operable to selectively output at least one of the time information, the non-time information, and the traceable record.

### CROSS-REFERENCE TO RELATED APPLICATIONS

This application claims priority to U.S. Provisional Patent Application No. 60/850,756, filed Oct. 11, 2006, the entire content of which is hereby incorporated by reference.

### BACKGROUND

1. Field

Embodiments of the invention relate generally to synchronous time systems and particularly to systems having time keeping devices synchronized by signals transmitted over a network (e.g., the Internet, wired and wireless local area networks (“LANs”) or wide area networks (“WANs”), etc.).

2. Related Art

Conventional hard-wired synchronous time keeping devices and systems (e.g., clock or bell systems, paging systems, message boards, etc.) are typically used in schools, industrial facilities, hospitals, etc. The devices in these systems are wired together in order to create a synchronized system. Because of the extensive wiring required in such systems, installation and maintenance costs may be high.

Conventional wireless synchronous time keeping devices and systems are not hard-wired, but instead rely on wireless communication among devices to synchronize a system. For example, one such system utilizes a government WWVB radio time signal to synchronize a system of clocks. This type of radio-controlled clock system typically includes a master unit that broadcasts a government WWVB radio time signal and a plurality of slave clocks that receive the time signal. To properly synchronize, the slave clock units must be positioned in locations where they can adequately receive the broadcast WWVB signal. Interference generated by power supplies, computer monitors, and other electronic equipment may interfere with the reception of the signal. Additionally, the antenna of a radio-controlled slave clock can be de-tuned if it is placed near certain metal objects, including conduits, wires, brackets, bolts, etc., which may be hidden in a building's walls.

### SUMMARY

The following summary sets forth certain exemplary embodiments of the invention. It does not set forth all such embodiments and is not limiting of embodiments of the invention.

Embodiments of the invention provide a time keeping system. The time keeping system includes a central control unit. The central control unit includes a transceiver and a processor. The transceiver is configured to receive time and non-time information from a wireless network and to send requests and status information to the wireless network. The processor is configured to store an internal time, receive the time information from the transceiver, update the internal time based on the time information received by the transceiver, send the requests and status information to the transceiver, and enable and disable the transceiver based on a schedule and/or at predetermined times.

In some embodiments, the time keeping system also includes a power management circuit. The central control unit can enable the power management circuit when the transceiver is enabled and can disable the power management circuit when the transceiver is disabled. When enabled, the power management circuit can be configured to supply regulated voltage of a power source to the central control unit and the transceiver. When the power management circuit is disabled, the power source can supply voltage directly to the central control unit. The power management circuit can include a boost converter configured to regulate voltage of the power source.

The time keeping system can also include a display configured to display the internal time. The time keeping system can also include at least one power source and a power management circuit. The time keeping system can further include at least one server configured to send the time information and the non-time information to the transceiver over the wireless network, receive the status information from the transceiver over the wireless network, and store the status information. In addition, the time keeping system can include software hosting services that provide at least one electronic form that a user can access over a network in order to view the status information received from the transceiver and configure the non-time information sent to the transceiver.

In some embodiments, a data center in communication with a plurality of remote wireless clocks of a network comprises a server in communication with the network. The network includes a wireless access point. The server is operable to send time information and non-time information through the network to a remote wireless clock among the remote wireless clocks. The server is also operable to receive status information through the network from the remote wireless clock, generate a traceable record based on the received status information, store the traceable record in a database, and host a software application for remote access by a user. The software application is operable to provide a plurality of functions associated with the remote wireless clock. The server is further operable to selectively output at least one of the time information, the non-time information, and the traceable record.

In other embodiments, a method of operating a data center in communication with a plurality of remote wireless clocks of network, the data center including a server operable to host a software application for remote access by a user, comprises sending, by the server, time information and non-time information through the network to a remote wireless clock among the remote wireless clocks. The method also includes receiving, by the server, status information through the network from the remote wireless clock; reporting, by the server, the condition information, to a remote user via the software application, based at least in part on the status information; and executing, by the server, a plurality of functions associated with the remote wireless clock via the software application.

In still other embodiments, a time keeping device configured for use with a server via a wireless network comprises a portable power source and a central control unit coupled to the portable power source and including a transceiver. The transceiver is configured to receive time information and non-time information from the server via the wireless network and is configured to send status information through the wireless network. The status information includes a power source life. The central control unit is operable to track an operating time of the portable power source, without monitoring a voltage of the portable power source, to determine the power source life. The time keeping device also includes a display coupled to the portable power source and the central control unit. The display is operable to display at least one of the time information and the non-time information.

### BRIEF DESCRIPTION OF THE DRAWINGS

FIG. 1 schematically illustrates a system of time keeping devices connected to a wireless area network according to one embodiment of the invention.

FIG. 1A schematically illustrates an alternate embodiment of the system shown in FIG. 1.

FIG. 1B schematically illustrates another alternate embodiment of the system shown in FIG. 1.

FIG. 2 schematically illustrates a central control unit included in a time keeping device of the system of FIG. 1 according to one embodiment of the invention.

FIG. 3 schematically illustrates a power management circuit included in a time keeping device of the system of FIG. 1 according to one embodiment of the invention.

FIG. 4 is a flowchart depicting an operational process of a server included in the system of FIG. 1 according to one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein are for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect. Also, electronic communications and notifications may be performed using any suitable means including direct connections, wireless connections, etc.

It should be noted that a plurality of hardware and software based devices, as well as a plurality of different structural components, may be utilized to implement embodiments of the invention. Furthermore, and as described in subsequent paragraphs, the specific configurations illustrated in the drawings are intended to exemplify embodiments of the invention, and other alternative configurations are possible.

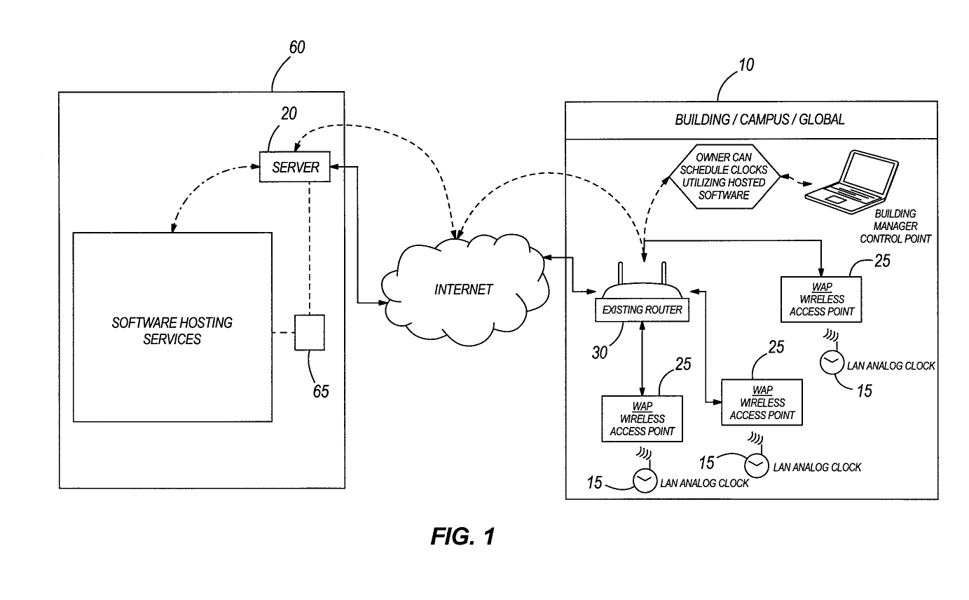

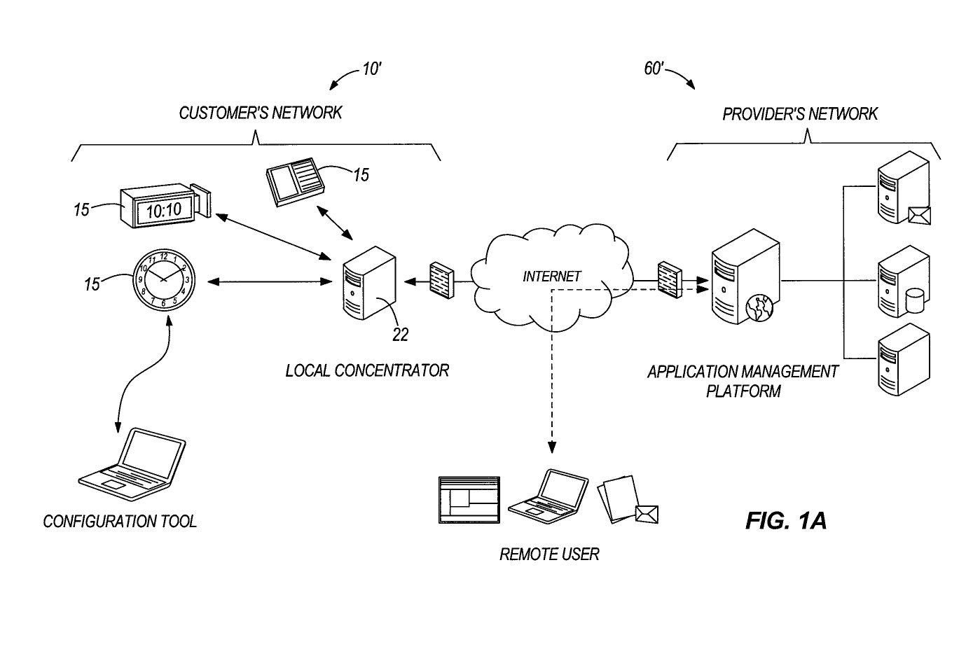

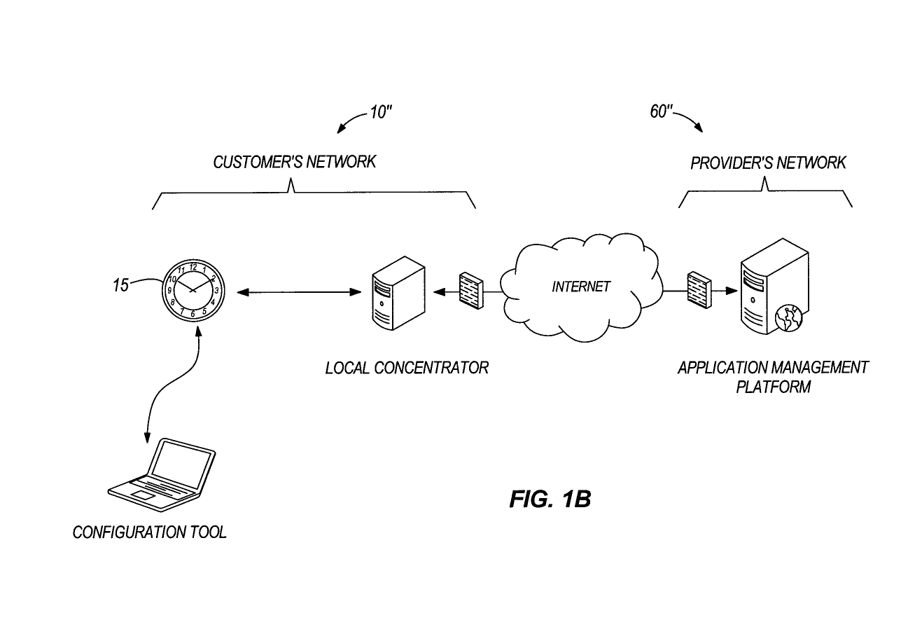

FIG. 1 illustrates a system 10 of one or more time keeping devices 15 (e.g., clocks) connected to a wireless network (e.g., a local area network (“LAN”)) according to one embodiment of the invention. Each time keeping device 15 illustrated in FIG. 1 can be intended for use in a home, office, school, university, hospital, etc. In such environments, the time keeping devices 15 may be distributed throughout rooms, floors, buildings, and other locations (e.g., outdoors), but are in communication with and monitored via the wireless network. In some embodiments, all or some of the time keeping devices 15 illustrated in FIG. 1 can include a clock with an analog and/or a digital display. Additionally or alternatively, the time keeping devices 15 can include portable devices.

The time keeping devices 15 illustrated in FIG. 1 can receive time information from a time source. As shown in FIG. 1, the time source can include a server 20. The time keeping devices 15 can include a network interface (e.g., a wireless local area network interface) that enables the time keeping devices to access one or more networks (e.g., an 802.11 compliant wireless LAN, a 802.16 compliant worldwide interoperability for microwave access (“WiMAX”) network, and/or a cellular communications network, such as a 3G+ network) through which the server is accessible (e.g., through a high-speed connection to the Internet). In some embodiments, each time keeping device 15 can access a wireless access point 25 (“WAP”) of a wireless network, which may include a router 30 or other intermediate systems and/or devices. In some embodiments, the time keeping devices 15 can interface with an existing network of an organization. For example, the time keeping devices 15 can share a network with other network devices, such as servers, personal computers, printers, cellular phones, etc. Using an existing network can reduce or eliminate the need for a separate wired or wireless system capable of providing time information to the time keeping devices.

Using the network interface, the time keeping devices 15 can request and receive time information from the server 20. The time information can include time, date, time zone offsets, daylight savings time status, etc. In some embodiments, the server 20 can also send non-time information to the time keeping devices, such as, for example, firmware updates, operation updates, programs, messages, etc. Each time keeping device can be uniquely addressable (e.g., via a unique Internet Protocol (“IP”), a media access control (“MAC”) address, or a domain name system (“DNS”) address), which allows the server 20 to provide customized time information and/or non-time information to a particular time keeping device. The time keeping devices 15 can also send information to the server 20 over the network. As described below, the information sent from the time keeping devices 15 can include status information, such as, for example, battery status, analog display status, temperature sensor status, light sensor status, motion sensor status, a hardware revision level, a software revision level, etc. Embodiments of the invention may significantly reduce unnecessary maintenance by allowing remote monitoring the system 10.

In addition, the system 10 is used for time synchronization and control of devices (e.g., devices utilizing a time keeping device) and actions. For example, the system 10 can facilitate access control; timing of events such as code blue initiation, duration, and completion; and initiation and control of events such as opening gates. In some embodiments (not shown), the system 10 includes a tone controller, a switch controller, and/or a code blue clock.

FIG. 1A illustrates another system 10′ of time keeping devices 15 connected to a wireless network. In this embodiment, the system 10′ includes a local concentrator 22 to consolidate or funnel information before it goes to or after it comes from the network. In some embodiments, the concentrator 22 may also act as the time source for the time keeping devices 15.

FIG. 1B illustrates another system 10″ of time keeping devices 15 connected to a wireless network.

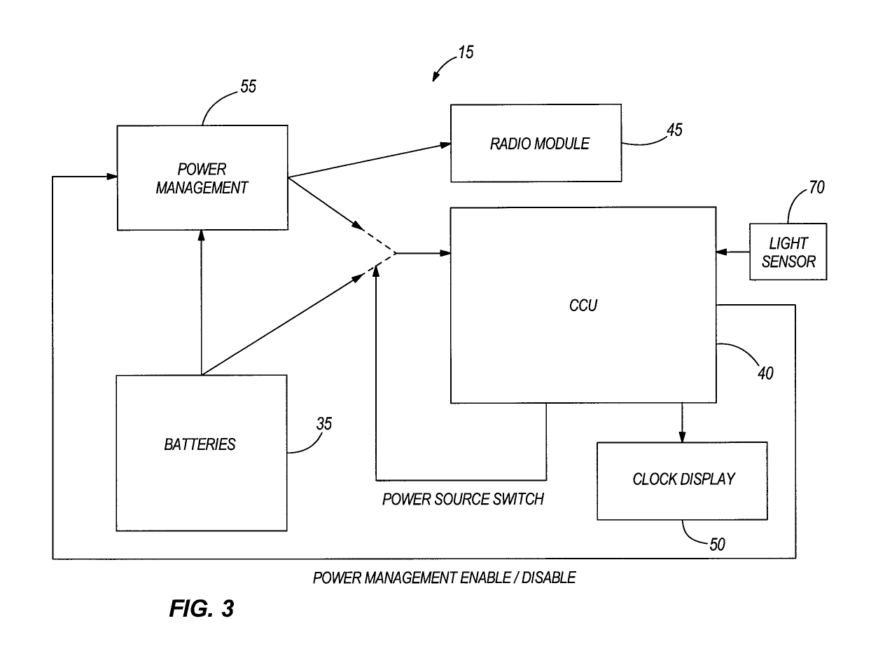

Each time keeping device 15 can include or be associated with a power source. The power source can include one or more batteries 35 (FIG. 3) and/or one or more solar panels for converting light to electricity. Using batteries, solar panels, or other wireless power sources, a time keeping device can be positioned in a location without requiring wiring for power. In some embodiments, a time keeping device can also include an interface (e.g., a plug) for receiving power from a wired power source (e.g., alternating current from a wall socket).

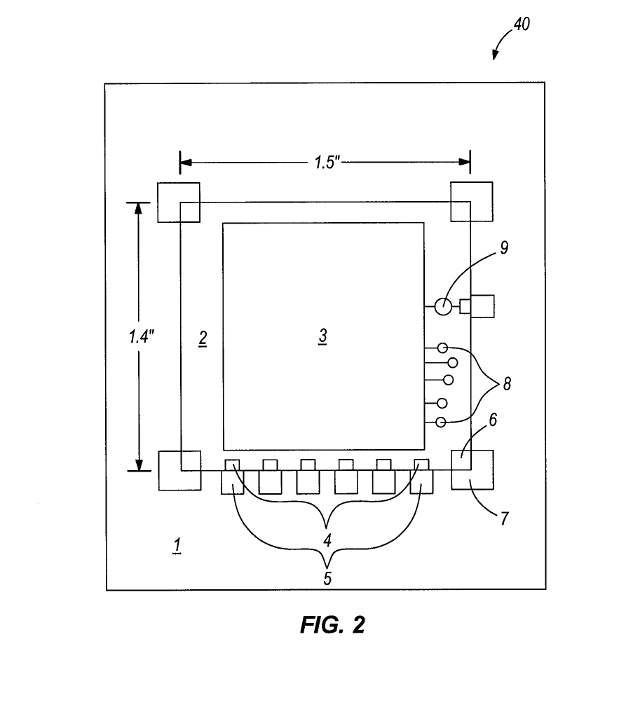

Each time keeping device 15 includes or is associated with a central control unit 40 (“CCU”), as shown in FIGS. 2 and 3. The CCU 40 can include a transceiver 45 (e.g., an 802.11 transceiver) with hardware and software necessary to send and receive information to and from one or more networks. The CCU 40 can also include a microprocessor capable of communicating with the transceiver, turning the transceiver on and off at appropriate times to conserve power, and controlling and/or communicating with other components of the time keeping device (e.g., a display). In some embodiments, a time keeping device can also include a display 50 and a power management circuit 55. The display 50 can include an analog display and/or a digital display and can display time information received by the time keeping device from the server. The power management circuit 55 can monitor battery voltage of a time keeping device and can regulate current consumption of the time keeping device in order to prolong the life of the batteries of the time keeping device.

It should be understood that the time keeping device 15 can include devices other than clocks. For example, the time keeping device 15 can include any device that requires or uses time or non-time information. Such devices can include clocks, security systems, paging systems, wireless tone generators (e.g., switching devices), message boards, alarm systems, medical devices (e.g., defibrillators, crash carts, etc.), worker attendance and time tracking systems, billing systems (e.g., legal billing systems), insurance claim handling systems, weather stations, etc. These devices can be equipped with a CCU in order to request time information and non-time information from the server 20. The devices can then use the information to time stamp information, display a time, determine whether to execute a program or program function (e.g., display a message, sound a tone, open a door, etc.), or perform other functions. For example, the server 20 can create a time stamp (e.g., a record of the current date and time) to mark when a device sent information, received information, performed an operation, etc. In embodiments where the device is a defibrillator, the server 20 can create a time stamp each time the defibrillator is used, for example.

In some embodiments, the CCU 40 includes a printed circuit board (“PCB”) connected to a PCB of the time keeping device (hereinafter referred to as the “application PCB”). The CCU 40 can also include an 802.11a/b/g/n compliant wireless LAN transceiver that is configured to communicate with an 802.11a compliant network, an 802.11b compliant network, an 802.11g compliant network, and/or an 802.11n compliant network using standard protocols. The transceiver can also support security mechanisms and protocols, such as the advanced encryption standard (“AES”), the wireless encryption protocol (“WEP”), the Wi-Fi protected access (“WPA”) protocol, the WPA2 protocol, 802.11 compliant security protocols, the remote authentication dial-in user server/service (“RADIUS”) protocol, and the extensible authentication protocol (“EAP”); can use the standard network time protocol (“NTP”) and/or the Simple Network Time Protocol (“SNTP”) to get time updates; can update firmware of the CCU 40; can update configuration settings of the CCU 40 by connecting to an external server; and/or can present a web page or similar electronic mechanism by which a user can change configuration settings of the CCU 40 using one or more protocols, such as the User Datagram Protocol (“UDP”) and/or the Transmission Control Protocol/Internet Protocol (“TCP/IP”).

The CCU 40 can also include a port (e.g., a serial port, RJ45 connector, or the like) that is configured to send and receive data between the CCU and a destination IP address (e.g., an external server or network device), relay network time protocol (“NTP”) time in a serial format to the CCU from an NTP server, update firmware of the CCU, and update configuration settings of the CCU.

Hardware in the CCU 40 can include an 802.11b radio that provides radio frequency (“RF”) processing and processing needed to provide 802.11b network communications. In some embodiments, the radio can be configured to work with 802.11b compliant wireless networks and/or 802.11g compliant wireless networks. In an exemplary implementation, the radio has a data rate of 1 to 11 megabits per second, a receiver sensitivity better than or equal to −93 dBm at 1 megabit per second, and a transmitter output power greater than or equal to 14 dBm+/−1 dBm.

The CCU 40 of a time keeping device can also include at least one power supply. The power supply can include one or more batteries (e.g., alkaline, nickel cadmium batteries, nickel metal hydride batteries, and/or lithium ion batteries). The power supply can be a different, additional power supply than a power supply for the time keeping device utilizing the CCU 40 or can be the same power supply. In some embodiments, the CCU 40 has a nominal operating voltage of 3.3 volts with a desired voltage range of 2.8 volts to 3.5 volts and an acceptable voltage range of 3.1 volts to 3.5 volts. The maximum current draw of the CCU 40 can be approximately 240 milliamps at 54 megabits per second.

FIG. 2 schematically illustrates a CCU 40 of a time keeping device according to one embodiment of the invention. As shown in FIG. 2, in some embodiments, the dimensions of the CCU 40 are approximately 1.5 inches wide by 1.4 inches long by 0.4 inches high. The CCU 40 includes a CCU PCB 2 that is connected to an application PCB 1. As shown in FIG. 2, the CCU 40 PCB 2 includes a shield 3. The shield 3 covers the components of the CCU PCB 2. General test points 8 for the CCU PCB 2, however, which are used for testing, programming, or debugging the CCU 40, can be extended outside of the shield 3 in order to provide easier access to the points 8.

As shown in FIG. 2, the CCU PCB 2 also includes pads 4 (e.g., board edge copper pads) used for connecting the I/O lines of the CCU PCB 2 to the application PCB 1. The functions of the I/O lines of the CCU PCB will be described below with respect to Table 1. The board edge copper pads 4 of the CCU PCB 2 make contact with (e.g., via soldering) pads 5 (e.g., board edge copper pads) of the application PCB 1. In some embodiments, the CCU PCB 2 includes a pad 5 at each corner in order to provide a secure mount to the application PCB 1.

As described above, the CCU 40 can include a radio transceiver, and the CCU PCB 2 can include an RF antenna output line or connector 9. In some embodiments, the RF antenna output line 9 can be connected to a board edge copper pad 4 and a test connector 8 on the CCU PCB 2. In some embodiments, the test connector 8 can include a Hirose W.FL-R-SMT(10) connector.

In some embodiments, the CCU 40 can be manufactured using an off-the-shelf or a proprietary chipset. For example, the CCU 40 can include the Realtek RTL8711 chip set manufactured by Realtek Semiconductor Corporation. The chipset can support one or more security protocols, such as the WPA2 protocol and the EAP protocol and can be used for a wireless access point and/or an audio and/or video digital media player.

The chipset can include a four-layer PCB with components mounted on one or more sides of the PCB. In some embodiments, the chipset can include various chips for performing various functions of the CCU 40. For example, the chipset can include a processor chip, an RF chip, an RF amplifier chip, an electrically erasable programmable read-only memory (“EEPROM”) chip, and a synchronous dynamic random access memory (“SDRAM”) chip. The RF chip in the chipset can include a receiver and a transmitter.

The chipset can also include an operating system (e.g., Linux) that manages the components of the chipset. In some embodiments, booting the chipset (e.g., the operating system and/or the components) can take approximately 5 seconds.

The I/O lines of the CCU PCB 2 can include the I/O lines and functionality as defined in Table 1. It should be understood that the order, number, and nature of connections can be modified.

TABLE 1

| Function | I/O | Description |
|---|---|---|
| Power | Input | Power supply connection for the CCU (multiple connections can be used |
| (e.g., 3.3 V) | | if needed). |
| Ground | Input | Ground connection for the CCU (multiple connections can be used if |
| | | needed). |
| Reset | Input | Reset Connection for the CCU (e.g., active low). Toggling this line |
| | | causes a full power on reset (“POR”). |
| Wireless | Output | 0 V if there is no wireless LAN activity, 3.3 V if there is activity. The LED |
| LAN | | can “flicker” to indicate data is being sent and received. |
| Activity | | |
| LED | | |
| Port Send | Output | 0-3.3 V serial line used for relaying information from a destination IP |
| | | address through the CCU to the time keeping device in a serial format, |
| | | sending NTP time in a serial format to the time keeping device, upgrading |
| | | the CCU firmware, updating the configuration settings, etc. |
| Port | Input | 0-3.3 V serial line used for relaying information from the time keeping |
| Receive | | device through the CCU and sending it to a destination IP address, |
| | | upgrading the CCU firmware, updating the configuration settings, etc. |

The CCU 40 can also include software or firmware executed by a processor included in the CCU 40. In some embodiments, software of a CCU establishes a unique MAC address for a CCU and, optionally, sends signal strength and/or quality information to the time keeping device upon request. For example, the time keeping device can request signal strength and/or quality information on the port of the CCU PCB, and the CCU can send the requested information to the time keeping device via the port or an analog output connected to the time keeping device.

In some embodiments, the CCU 40 can be configured in various manners. For example, the CCU 40 can be configured from the port, via a web page, and/or from an external server (destination IP address). Table 2 shown below includes a list of exemplary configuration items for the CCU 40 that can be updated on either the port, a web page, or from a destination IP address. In some embodiments, the IP address can be static, dynamic, or part of a subnet on a VLAN, for example.

TABLE 2

| Function | Description |
|---|---|
| Addressing | Static or Dynamic |
| WLAN MODULE IP | Example: 192.168.192.201 |
| Gateway IP | Example: 192.168.192.001 |
| Netmask | Example: 255.255.255.0 |
| DHCP Device Name | Name of the Device |
| Port Baud Rate | 2400 bps-38400 bps |
| WLAN Module Source | Example: 1600 |
| Port | |
| Destination IP Port | Example: 1600 |
| Destination IP Address | Example: 192.168.192.100 |
| NTP Server IP Address | Example: 129.6.15.28 |
| Topology | Infrastructure or AdHoc |
| SSID | Name of the WLAN Network |
| Channel | 1 to 13 |
| Security | None, WEP, WPA, or WPA2 |
| Authentication | None, Shared |
| Encryption | None, WEP64, WEP128, or TKIP |
| Key Type | Hex or Passphrase |
| Key | Security Key Code |

In some embodiments, configuration settings of the CCU 40 can be updated via a web page or similar network-accessible electronic form. The CCU 40 can also be configured to accept configuration settings and/or firmware updates from a destination IP address whenever updates are available. In some embodiments, configuration settings of a CCU can be updated based on a predetermined schedule. For example, configuration items can be updated immediately once they are available, the next time the CCU is powered up, and/or at a defined time and/or date.

The port of the CCU 40 can be used for general communications between the CCU 40 and a destination IP address. For example, data sent from a destination IP address can be received by the CCU 40, converted to serial format, and sent through the port to other components of the CCU 40 (e.g., software executed by the CCU). Similarly, data sent to the CCU 40 can be received through the port, converted to a wireless LAN communications format, and sent to a destination IP address.

In some embodiments, the CCU 40 receives SNTP time from a predefined NTP server. The time received by the CCU 40 is packaged by the CCU 40 into a serial format and sent through the port to the time keeping device (e.g., the application PCB) at the start of the next second. In some embodiments, the start of the transmission of the serial time packet occurs within 1 millisecond of the actual start of the second indicated in the time information received from the NTP server.

As noted above, the port of the CCU 40 can also be used to download configuration settings to the CCU 40 and receive updates to firmware of the CCU 40. Updates to firmware of the CCU 40 can include security updates, protocol updates, etc. In some embodiments, the port of the CCU 40 can be configured with a baud rate of 2,400 bits per second to 38,400 bits per second, without flow control, and with 8 data bits, no parity bits, and 1 stop bit.

In some embodiments, software in the CCU 40 can be compliant with the following Internet Engineering Task Force (“IETF”) requests for comments (“RFCs”): RFC 2030-SNTP Version 4.0, RFC 768-UDP, RFC 791-IP Version 4, and, optionally, RFC 1883-IP Version 6.

When the CCU 40 is powered up, the CCU 40 can automatically turn on its 802.11b wireless LAN radio transceiver, acquire a dynamic host configuration protocol (“DHCP”) IP address if needed, and then obtain SNTP time from the predefined NTP server. Once the CCU has completed these actions, the CCU can update its time once an hour at the start of each hour. Also at power up, the CCU can make a connection to the destination IP address and begin sending and/or receiving data when it is available.

The CCU 40 can be configured to operate within a thermal operating range of −40° C. to +70° C. and can be configured to be stored in a non-operating state within a thermal storage range of −40° C. to 85° C. In some embodiments, the CCU 40 can also be FCC and CE compliant.

As described above, the CCU 40 in a time keeping device can be configured over a network, such as the Internet, by accessing a software application provided by a service provider (e.g., a hosted software service provider that hosts a web page). As shown in FIG. 1, the service provider may provide a data center 60 that includes the server 20. In some embodiments, the server 20 can be implemented as multiple collocated or remote hardware and software devices (e.g., servers). The data center 60 can run an application management platform and can allow an individual, via the software application, to register an identification number or string of a time keeping device and program the time keeping device. For example, an individual can use the software application to select a time zone associated with a time keeping device, enable or disable daylight savings time automatic adjustments for a time keeping device, etc. In some embodiments, the software application can be implemented as multiple applications. The individual can access the software application using a network device, such as a personal computer, connected (e.g., via the Internet) to the server 20 or other device providing the hosted services. In some embodiments, an individual can also use the software application to view information about a particular time keeping device. For example, an individual can use the data center 60 to access a record of the last time or times that a particular time keeping device requested time information and/or non-time information from the server 20. In other embodiments, the data center 60 may be staffed by system administrators or other personnel that may interact with remote users via, for example, terminals, the Internet, voice over IP (VoIP), or the like.

In some embodiments, an individual can use the software application to view information sent to the server 20 from a time keeping device 15. As described above, a time keeping device 15 can send status information to the server 20. The status information can include identification information (e.g., the device's address, identifier, owner, etc.), battery status information, environment information (e.g., temperature information, light information, etc.), position information (e.g., latitude and/or longitude information, etc.), usage information (e.g., usage of a door, light, defibrillator, etc.), time-stamped digital data, display information (e.g., the position of the hands of an analog clock display), drift information (e.g., the difference between the previous time maintained by the time keeping device and the most current time information received from the server), etc.

The information sent from a time keeping device 15 to the server 20 can be stored and maintained (e.g., in a database 65 of the data center 60) and recalled by an individual (e.g., via the software application or a separate data management service) in order to trace and review the operation of the time keeping device 15. In some embodiments, the server 20 can generate a traceable record of the status information from the time keeping device 15 such that an individual can recall and view the record at a later date. For example, a hospital administrator, insurance company, or governmental entity can view the traceable record of a time keeping device within or associated with a defibrillator in order to track when (e.g., at what time via a time stamp) the defibrillator was used, how long it was used, where it was used, who used it, etc., which is established by the CCU of the defibrillator based on the time information received from the server 20 and the status information of the defibrillator. The time keeping device of the defibrillator can assemble and send such information to the server 20, which can create a traceable record of this information, which may be viewed or otherwise employed by the hospital administrator, insurance company, or governmental entity. Providing accurate time to the time keeping device from the server 20 and maintaining a traceable record of information exchanged between the server 20 and the time keeping device can help establish legal and/or verifiable records of the operation of the time keeping device.

As shown in FIG. 1, based on internal programming, each time keeping device's microprocessor turns on its transceiver and requests time information and/or non-time information from the server 20. In some embodiments, the time keeping devices 15 receive Network Time Protocol (“NTP”) time from the server 20. The server 20 can transmit the NTP time in Greenwich Mean Time (“GMT”) format or Coordinated Universal Time (“UTC”) format. Once a time keeping device 15 receives the NTP time from the server, the time keeping device 15 transmits its identification number or other identifier back to the server 20. The server 20 then responds with the correct GMT offset and daylight savings time status associated with the specific identifier provided by the time keeping device 15 (e.g., which is previously configured by an individual managing the time keeping device 15 using the data center 60 as described above). The server 20 can also transmit additional information to a time keeping device 15, such as weather conditions and alerts, programs, messages, etc. As also described above, after a time keeping device 15 has received time information from the server 20, the time keeping device 15 can transmit status information to the server 20. Status information can include software version information, hardware version information, information regarding the time at which the last update occurred, battery status information, operation information, signal strength information, midnight verification information, etc.

In some embodiments, the transceivers 45 of the time keeping devices can initiate communication with the server 20 and request information from the server 20 rather than force the server 20 to attempt to send information to the time keeping devices 15 unsolicited.

In some embodiments, each transceiver 45 of a time keeping device can be programmed with one or more schedules for requesting information from the server 20. If a time keeping device is programmed with multiple request schedules, one of the schedules can be set as the default schedule (e.g., during manufacture and/or post-manufacture). In some embodiments, when the server 20 responds to a request from a time keeping device, the server 20 can change the request schedule of the transceiver to a different schedule programmed in the time keeping device or can download a new request schedule to the time keeping device. By allowing the server 20 to remotely modify the request schedule of one or more time keeping devices, the server 20 can remotely optimize the time keeping devices with respect to power consumption and the timely relaying of information. For example, when there is little change in information (e.g., weather information) to be sent to a time keeping device (e.g., at night or during calm weather), the server 20 can set the request schedule of the time keeping device to a slow request rate (e.g., one request every 15 minutes). When there is more information to be sent to a time keeping device (e.g., during severe weather conditions), the server 20 can set the request schedule of the time keeping device to a higher request rate (e.g., one request every minute). In some embodiments, the server 20 can also adjust the individual request schedules of one or more time keeping devices in order to optimize communication with multiple time keeping devices by avoiding the clustering of requests for information. The server 20 can also adjust individual request schedules of multiple time keeping devices in order to optimize battery consumption of the time keeping devices 20 by minimizing request delays due to traffic congestion.

In some embodiments, in addition to or in place of the traffic controls described above, a server can regulate traffic by redirecting a time keeping device to request information from a different server having a different IP address. For example, if a particular server is receiving more requests than it can handle efficiently, the server can direct excess requests to an address of another server and/or can instruct one or more time devices to resend their requests to another server.

After a time keeping device transmits status information to the server 20, the server 20 can transmit needed firmware or configuration updates to the time keeping device. Firmware updates include changes to the internal programming of a time keeping device (e.g., the CCU). Configuration updates include feature changes, such as how often a time keeping device should turn on its transceiver and request updated information. After operations are complete, the microprocessor can shut down or turn off the transceiver in order to conserve power of a time keeping device.

In some embodiments, power management features are provided for a wireless time keeping device. Wireless time keeping devices connected to a wireless network can be powered by, for example, alternating current (“AC”) sources or rechargeable batteries. Because the time keeping devices 15 illustrated in FIG. 1 only need to turn on their transceivers 45 for a short amount of time each day, the time keeping devices 15 can be run on regular primary, non-rechargeable batteries. In some embodiments, the time keeping devices 15 illustrated in FIG. 1 can include additional power management features. For example, if a time keeping device includes an analog clock display, the time keeping device can include a light sensor 70 (FIG. 3) that detects when the time keeping device and/or the analog clock display is located in a dark environment. If such an environment is detected, the time keeping device (e.g., the microprocessor) can stop or disable the movement of the second hand of the analog clock display on a dual motor movement in order to conserve battery power of the time keeping device. The time keeping device can continue to keep time by stepping the minute and hour hands of the analog clock display. In some embodiments, disabling the second hand when the time keeping device is located in a dark environment can increase the battery life of the time keeping device by approximately 25%. Disabling the second hand can also potentially decrease noise generated by the time keeping device when the time keeping device is located in a dark environment where people are sleeping. When the light sensor 70 detects that the time keeping device is no longer located in a dark environment, the time keeping device can enable the second hand and rapidly advance the second hand to the correct position.

In some embodiments, a time keeping device can include a tilt sensor. Output from the tilt sensor can be used to determine if the time keeping device has been moved or tampered with or is positioned incorrectly. For example, if a time keeping device includes a display that indicates the time maintained by the time keeping device, the CCU 40 can transmit output from the tilt sensor as status information to the server. An individual accessing the status information can use the output from the tilt sensor to determine if the time keeping device is positioned on a wall or other surface incorrectly (e.g., such that the time displayed by the device cannot be easily read) or has been moved (e.g., stolen). If the time keeping device is still within range or connected to a network (e.g., still within range of a wireless network), the server or another device can use triangulating signals or other location determination methods in order to determine the location of the moved clock. In some embodiments, if an individual determines that a time keeping device has potentially been stolen, the individual can configure the time keeping device to generate an audible sound (e.g., via a web page). The audible sound can help identify, track, and deter theft of a time keeping device. An individual can also deactivate the audible sound (e.g., via a web page).

As noted above, if a time keeping device is connected to or within range of a network, the location of the time keeping device can be determined. For example, the server 20 or another device can use triangulating signals to automatically determine the location of a time keeping device. In some embodiments, the server 20 uses the determined location of the time keeping device to automatically set time zone or other location-dependent configuration settings of the time keeping device.

As described above, a time keeping device can track the status of its batteries (e.g., the batteries 35 in FIG. 3). In some embodiments, a time keeping device can track its battery status in multiple manners. A first manner can include tracking battery voltage using a standard tracking method. A second manner can include tracking operating time. In particular, since the battery voltage of a lithium or lithium-based battery does not decrease slowly, but drops rapidly at the end of its life, battery voltage is not generally an absolute battery life indicator for lithium batteries. To more accurately track the battery life of lithium batteries, the length of time, or amps per hour times the number of hours of actual use of the battery, since the battery was put in service can be tracked. Using one or both of the above battery life tracking manners, a time keeping device can determine its battery status and transmit the battery status information to the server 20. The server 20 can then notify or alert an individual (e.g., via an electronic page, an email, an electronic or printed report, etc.) of a battery needing replacement before the battery is substantially depleted.

In some embodiments, a time keeping device can also track battery voltage in order to determine whether its power source has adequate power to keep the device powered during a firmware update. If the time keeping device loses power during a firmware update, an incomplete firmware download can cause the time keeping device to function improperly or not at all. Therefore, to attempt to prevent incomplete firmware downloads, the time keeping device can check the voltage of its batteries to ensure that adequate power remains to keep the time keeping device powered during the update. After a time keeping device checks the battery voltage, the time keeping device can alert a server as to whether the server should proceed with the firmware update.

FIG. 3 illustrates a power management circuit 55 of the CCU 40 according to one embodiment of the invention. As noted above, in some embodiments, the CCU 40 can be configured to use non-rechargeable batteries as a power source, and, in order to extend the life of the batteries, the CCU 40 can monitor and manage battery use. In some embodiments, the radio module 45 (e.g., the transceiver) includes a processor that is configured to run the entire device, but draws more current than the CCU 40. As such, the CCU 40 can be configured to manage and monitor battery use because of its low current consumption. In an exemplary implementation, the CCU 40 includes a Texas Instruments MSP430 microprocessor.

In some embodiments, the operating voltage range of the radio module 45 can cause battery management issues. For example, in one exemplary implementation, the radio module 45 can be configured to operate within the 2.8-3.5 volt range and the CCU 40 can be configured to operate within a larger voltage range (e.g., 1.8-3.5 volts). Because of the larger operating voltage range of the CCU 40, using the CCU 40 to monitor and manage battery use (and/or other operations of the time keeping device) can further improve the battery life of the time keeping device 15. In some embodiments, the radio module 45 has a large current draw that can also cause battery management issues. For example, in some exemplary implementations, the radio module 45 draws approximately 240 milliamps when it is active. A standard battery's voltage (e.g., an alkaline battery's voltage) can sag when the battery is placed under such a large draw.

To overcome any or all of the above battery management issues, the time keeping device 15 can include the power management circuit 55. The power management circuit 55 can include a direct current (“DC”) to DC converter (e.g., a boost converter). The DC to DC converter is used to regulate the battery voltage to a predetermined voltage (e.g., 3.3 volts). By regulating the voltage of the batteries 35, the radio module 45 can operate off of the predetermined voltage (e.g., 3.3 volts) no matter the actual voltage of the batteries 35. In some embodiments, the power management circuit 55 is not used in association with the CCU 40 because even though DC to DC converters can be efficient in high current draw situations, they can be inefficient in low current draw situations, such as involving the CCU 40.

In some embodiments, in order to further optimize battery life of a time keeping device, the power management circuit 55 of a time keeping device can be disabled or turned off during normal operation of the time keeping device (e.g., when the radio module is turned off). When the radio module 45 is turned on, however, the CCU 40 can use a power source switch or control line to switch its power supply from the batteries 35 to the power management circuit 55 and can turn on or enable the power management circuit 55 (e.g., via a power management enable/disable control line). In some embodiments, the CCU 40 switches to the power management circuit 55 when the radio module 45 is turned on in order to avoid a difference in voltage between the CCU 40 (e.g., operating at 2.2 volts) and the radio module 45 (e.g., operating at 3.3 volts). For example, a voltage difference between the CCU 40 and the radio module 45 could cause input ports on the CCU 40 to fail due to high voltage levels.

In some embodiments, the time keeping device 15 can also include a battery voltage sensing circuit. When the battery voltage sensing circuit determines that the batteries have reached a predetermined low voltage range (e.g., the 1.8 to 2.0 volt range), the CCU 40 can use the power source switch to switch its power source from the batteries 35 to the power management circuit 55. Even though the time keeping device 15 draws more current due to the power management circuit 55 being turned on continuously, using the power management circuit 55 can extend the battery life of the time keeping device 15 because the batteries 35 will be able to run down below an otherwise insufficient voltage level (e.g., 1.8 volts), and the time keeping device 15 can continue to function.

In some embodiments, users can also use the software application to remotely verify that a time keeping device is operating correctly and/or maintaining or displaying correct time information. For example, a time keeping device that includes an analog clock display can include optical mechanisms to determine the positions of one or more hands of the analog clock display. The time keeping device can transmit the hand positions to the server, and an individual can access the hand position information via the software hosting services in order to identify whether or not the time keeping device is functioning properly.

It should be understood that in some embodiments a time keeping device can be a stand-alone device that directly receives time information and/or non-time information from the server. In other embodiments, a time keeping device can be a secondary or slave device that receives time information and/or non-time information indirectly from the server through a master time keeping device. The master time keeping device can receive time information and non-time information directly or indirectly from the server via a wireless LAN and can transmit information to the slave time keeping devices. The slave time keeping devices can receive the time information and non-time information from the master device via a network transmission (e.g., via a wireless LAN), a radio frequency transmission, and/or another mechanism for providing wired and/or wireless communication. A system of time keeping devices can also include one or more repeaters that directly receive time information and/or non-time information from the server and/or a master time keeping device and amplify and/or filter the information before transmitting the information to additional master time keeping devices and/or secondary devices. The repeaters can expand the service or transmission area of a master device.

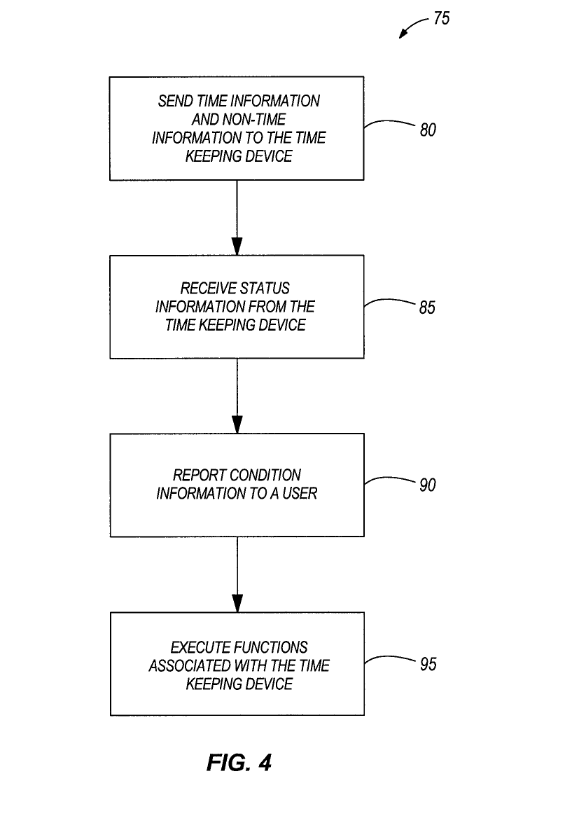

FIG. 4 is a flowchart depicting an operational process 75 of the server 20 with respect to the time keeping devices 15 according to one embodiment of the invention. At step 80, the server 20 sends time information and non-time information to one or more of the time keeping devices 15 through a wireless network. At step 85, the server 20 receives status information from the time keeping device(s) 15 through the wireless network. At step 90, the server 20 reports condition information that is based on or associated with the status information to a user via the software application of the data center 60. At step 95, the status server 20 executes one or more functions of the time keeping device(s) 15.

Although the flowchart illustrates the steps of the process 75 in a particular order, the steps 80-95 discussed above may be performed in a variety of orders. For example, the server 20 may receive status information (e.g., step 85) and/or execute a function (e.g., step 95) prior to sending the time information or non-time information to the time keeping device 15 (e.g., step 80). As such, the illustrated flowchart merely depicts one specific order of operations carried out by the server 20. Further, additional and/or alternative steps can be implemented, or one or more of the illustrated steps may be omitted.

Various features and advantages are set forth in the following claims.

1. A data center in communication with a plurality of remote wireless clocks of a network, the data center comprising:
a server in communication with the network, the network including a wireless access point, the server operable to send time information and non-time information through the network to a remote wireless clock among the remote wireless clocks,
the server operable to receive status information through the network from the remote wireless clock,
the server operable to generate a traceable record based on the received status information and to store the traceable record in a database,
the server operable to host a software application for remote access by a user, the software application operable to provide a plurality of functions associated with the remote wireless clock, and
the server operable to selectively output at least one of the time information, the non-time information, and the traceable record.

2. The data center of claim 1, wherein the traceable record includes a time stamp associated with an operation of the remote wireless clock.

3. The data center of claim 2, wherein the time stamp includes a date and a time of a status change of the remote wireless clock.

4. The data center of claim 1, wherein the remote wireless clock is a module of a medical device.

5. The data center of claim 4, wherein the traceable record includes information regarding an operation performed by the medical device and a time stamp associated with the operation of the medical device.

6. The data center of claim 1, wherein the remote wireless clock is a module of an alarm system.

7. The data center of claim 6, wherein the traceable record includes information regarding a status change of the alarm system and a time stamp associated with the status change.

8. The data center of claim 1, wherein the data center is operated by a hosted software provider.

9. A method of operating a data center in communication with a plurality of remote wireless clocks of a network, the data center including a server operable to host a software application for remote access by a user, the method comprising:
sending, by the server, time information and non-time information through the network to a remote wireless clock among the remote wireless clocks;
receiving, by the server, status information through the network from the remote wireless clock;
reporting, by the server, condition information to a remote user via the software application, based at least in part on the status information; and
executing, by the server, a plurality of functions associated with the remote wireless clock via the software application.

10. The method of claim 9, wherein the status information includes position information associated with the remote wireless clock.

11. The method of claim 9, wherein the status information includes environment information associated with the remote wireless clock.

12. The method of claim 9, wherein the status information includes time drift information associated with the remote wireless clock.

13. The method of claim 9, wherein the remote wireless clock is a module of a device, and wherein the status information includes usage information associated with the device.

14. The method of claim 9, wherein the remote wireless clock is a module of a medical device, and wherein the condition information includes a time stamp associated with an operation of the medical device.

15. A time keeping device configured for use with a server via a wireless network, the time keeping device comprising:
a portable power source;
a central control unit coupled to the portable power source and including a transceiver, the transceiver configured to receive time information and non-time information from the server via the wireless network and configured to send status information through the wireless network, the status information including a power source life, the central control unit operable to track an operating time of the portable power source, without monitoring a voltage of the portable power source, to determine the power source life; and
a display coupled to the portable power source and the central control unit, the display operable to display at least one of the time information and the non-time information.

16. The time keeping device of claim 15, wherein the central control unit is operable to track the operating time of the portable power source by measuring a period of time since the power source was put in service.

17. The time keeping device of claim 15, wherein the central control unit is operable to track the operating time of the portable power source by multiplying amps per hour used of the portable power source and number of hours of use of the portable power source.

18. The time keeping device of claim 15, wherein, when the power source life falls below a predetermined threshold, the transceiver is operable to send an alert to the server to remotely notify a user.

19. The time keeping device of claim 15, wherein the portable power source includes at least one lithium-based battery.

20. The time keeping device of claim 15, further comprising a light sensor operable to detect when the time keeping device is located in a dark environment.

21. The time keeping device of claim 20, wherein the display includes an analog clock display, and wherein, when the time keeping device is located in the dark environment, the central control unit disables movement of a second hand of the analog clock display.

22. The time keeping device of claim 15, wherein the power source life is monitorable by a remote user via the server.
